(19) United States
(12) Patent Application Publication
(10) Pub. No.: US 2018/0259928 A1
(43) Pub. Date: Sep. 13, 2018

(54) CONTROL BOX

(71) Applicant: Marci A. Brogan, Pentwater, MI (US)

(72) Inventor: Marci A. Brogan, Pentwater, MI (US)

(73) Assignee: OMT-Veyhl USA Corporation, Holland, MI (US)

(21) Appl. No.: 15/916,996

(22) Filed: Mar. 9, 2018

Related U.S. Application Data
(60) Provisional application No. 62/469,076, filed on Mar. 9, 2017.

(51) Int. Cl. G05B 19/042; H04H 60/65; H04N 21/466

(52) U.S. Cl. CPC G05B 19/0426; H04N 21/4667; H04H 60/65

(57) ABSTRACT

A control box that provides auto configuration of maximum height, minimum height and speed with use of a current monitoring circuit and software algorithms to work with adjustable height desks without the necessity of specific configuration files.

### CROSS REFERENCE TO RELATED APPLICATIONS

This application claims priority to U.S. provisional application Ser. No. 62/469076 entitled “Control Box,” filed Mar. 9, 2017.

### FIELD OF INVENTION

The present invention is in the field of control boxes for the manipulation of tables.

### BACKGROUND

Workstations for use in manufacturing and other industries have long been known. Such workstations generally include left and right side upright structures called “legs,” which are mounted on bases or wheeled feet for support and mobility and which may be adjusted to set the table top of the workstation at a desired height. The legs are connected together at their upper ends by a frame member for supporting the table top or work surface on which the manufacturing or assembly are performed.

It is desirable in workstations of this nature that the table top be adjustable in height. In many workstations, a central control box is used to manipulate electric motors that adjust the height of the table top. However, these control boxes are susceptible to over adjusting and damaging the height adjustment mechanism. Therefore, a need exists for a control box that provides auto configuration of maximum height, minimum height and speed with use of a current monitoring circuit and software algorithms to work with adjustable height desks without the necessity of specific configuration files.

### BRIEF DESCRIPTION OF THE DRAWINGS

FIG. 1 is a disassembled view of an embodiment of the control box;

FIG. 2 is a perspective view of the PCB assembly;

FIG. 3 is a front view of the hand switch; and

FIG. 4 is a diagram of the wiring of an embodiment of the control box.

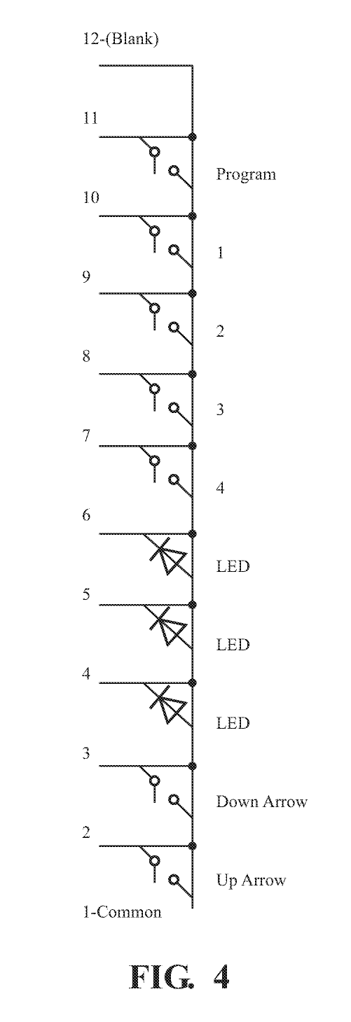

### DESCRIPTION

The following description is presented to enable any person skilled in the art to make and/or use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest possible scope consistent with the principles and features disclosed herein.

The inventive control box 1 provides auto configuration of maximum height, minimum height and speed with use of a current monitoring circuit and software algorithms to work with adjustable height desks without the necessity of specific configuration files. This provides cost benefit and efficiencies within manufacturing. The control box 1 includes a hand switch 2 and an external switched mode power supply 3. In the preferred embodiment, the control box 1 comprises a hand switch 2 are integrated into a housing 4. The hand switch 2 is on a flexible circuit and adhered to a recessed area of the housing 5. Installation (initialization) is simplified with a press and hold of the “P” button 6. In some preferred embodiments, an optical feedback may be provided in the form of an LED light 7. This LED light 7 coordinates the status of the control box 1 with status LED 7 on the hand switch 2. The control box 1 may incorporate micro USB connection 8 for connecting to a computer with a common cable for trouble shooting and data usage analytics and for charging devices.

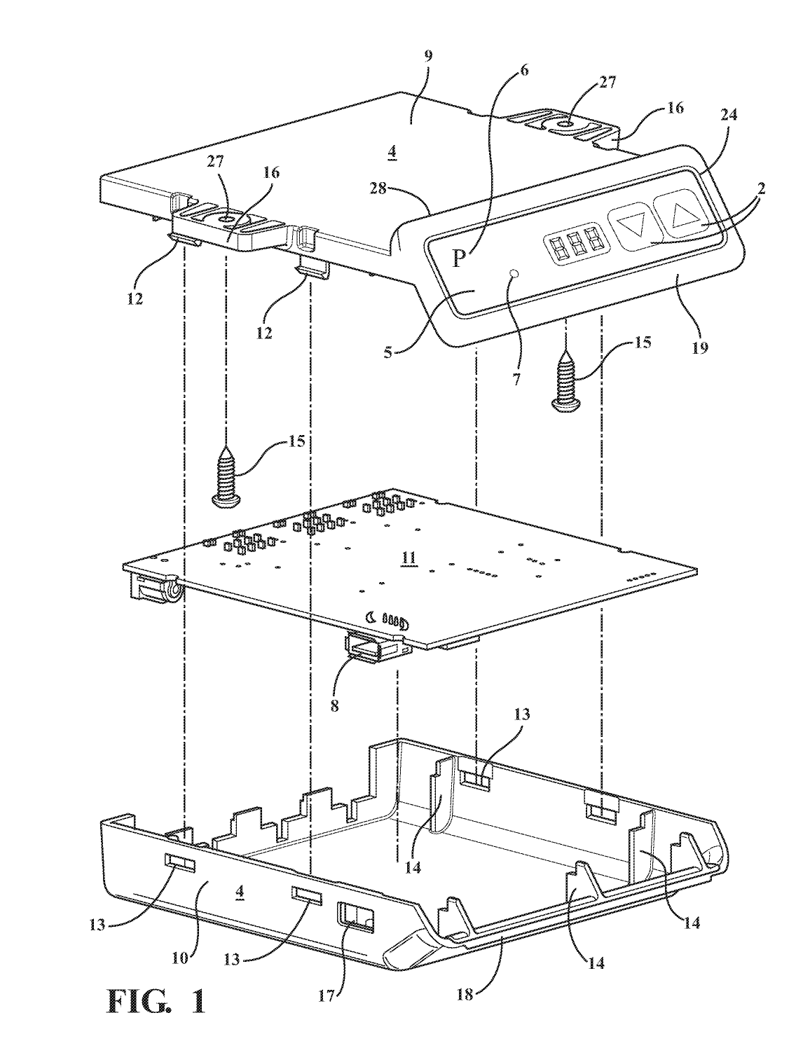

As shown on FIG. 1, the control box 1 further comprises an upper housing 9, a lower housing 10, and a PCB assembly 11. In preferred embodiments, the upper housing 9 is constructed of plastic and configured to connect to a lower housing 10 and support the PCB assembly 11. Hooks 12 on the upper housing 9 snap into holes 13 on the lower housing 10. In such embodiments, the PCB assembly 11 or printed circuit board assembly is typically placed between the upper housing 9 and lower housing 10. Posts 14 in the lower housing 10 support the PCB assembly 11 and locate it within the control box 1. Mounting screws 15 may also be utilized to connect the upper housing 9 to the underside of the table top. A mounting screw boss 16 may also be used to help facilitate this connection. In some preferred embodiments, a hole 17 for a USB port is incorporated into the lower housing 10. In some embodiments, the lower housing 10 may be configured with a lower housing attachment rib 18 that may be used to facilitate the connection of the front of the lower housing 10 to the trim 19 surrounding the integrated keypad face 24 residing in the front of the upper housing 9.

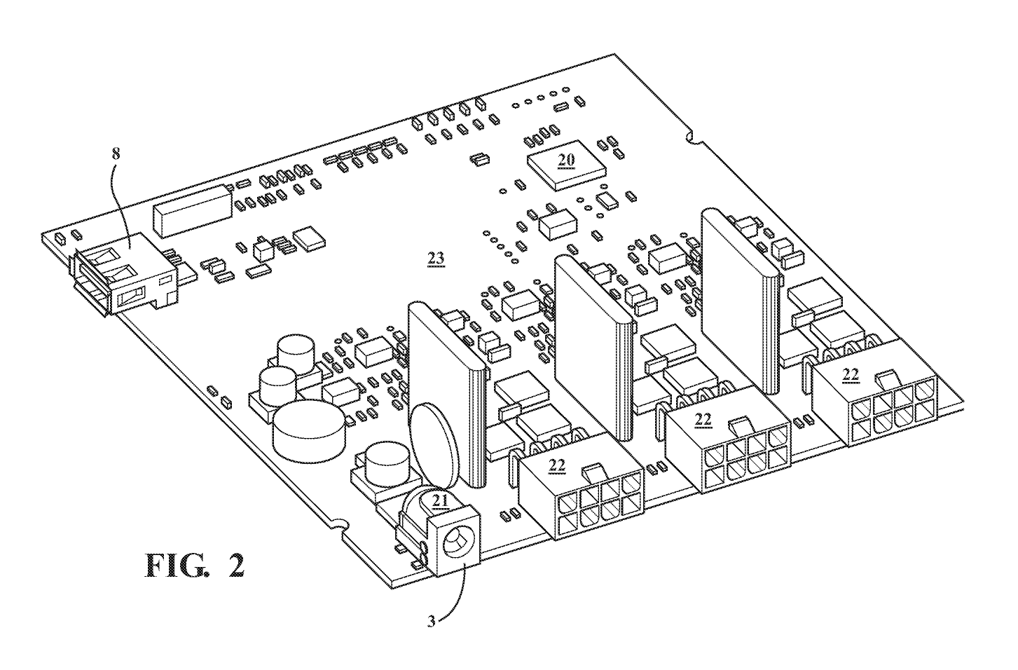

The purpose of the PCB assembly 11 is to receive the user input form the hand switch 2. As depicted in FIG. 2, in preferred embodiments the PCB assembly 11 comprises a microprocessor 20, a power connector 21, a motor connection port 22, and a circuit board 23. In some preferred embodiments, a USB charging connection 8 may be added to the PCB assembly 11. Software in the microprocessor 20 changes user input for the hand switch 2 into the desired output. This desired output is in many cases is the manipulation of at least one motor located in the table. However, the microprocessor 20 may also be programmed to perform other functions or may be used to store user data.

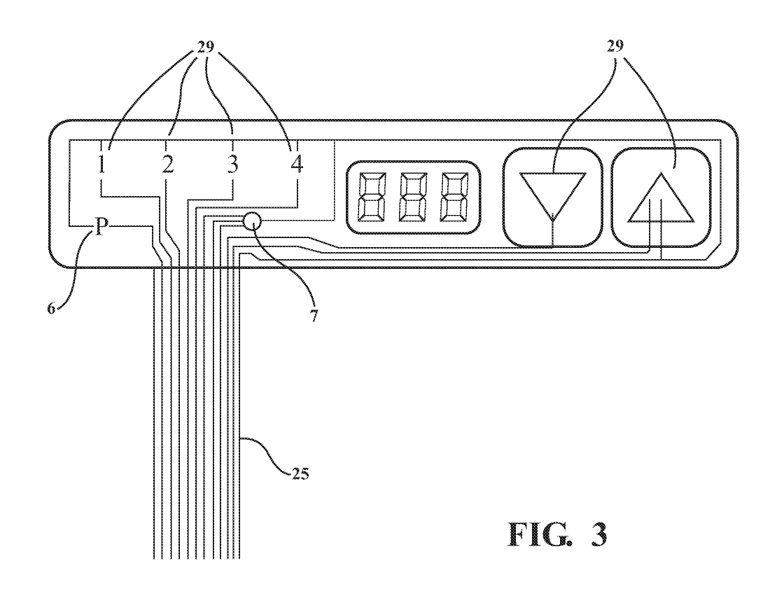

Integrated keypad face 24 is an indentation in the upper housing 9 formed to receive the hand switch 2. The “tail” 25 is the combined wiring running to the hand switch 2. In preferred embodiments the tail 25 contains twelve wires as shown on the left of FIG. 3. There may also be a hole 26 in the keypad face 24 (not shown) that receives the tail 25.

Mounting holes 27 are used to connect the control box 1 to the table. In the preferred embodiment mounting screw bosses 16 extend out of the control box 1 on at least the right and left sides of the upper housing 9. In the preferred embodiment the mounting screw bosses 16 are oriented to the top of the control box 1 to facilitate the attachment of the control box 1 to the underside of the table top using mounting screws 15. When mounted to the underside of a table top, the table top locating edge 28 presses up against the edge of the table top.

FIG. 3 shows hand switch 2 configuration. When setting up the control box 1, a user may press and hold the “P” button 6 for auto calibration. When auto calibration is selected, a monitor built into the software stored on PCB assembly 11 monitors how much power is going through each of the motors in the table as the height is adjusted. An algorithm programed into the microprocessor 20 is used to find the top and bottom limits of travel by finding the power spike in the motors when the table hits the bottom and top limits. The algorithm sets the maximum and minimum heights just a little bit less than the limits to set the top and bottom positions of the table. A plurality of buttons 29 may be added to the keypad face 24 for programmable preset heights. Such preset height settings may be useful to the user to store sitting, stool, or standing heights. In preferred embodiments, a status LED light 7 on the hand switch 2 provides feedback to the user. When the control box 1 is working, the status light is green. A blue status light may be used to show need for calibrations. A red status light may indicate an error.

1. A control box comprising:
a PCB assembly;
a hand switch; and
an external power supply.

2. The control box of claim 1 wherein the PCB assembly and hand switch are integrated into a common housing.

3. The control box of claim 2 wherein the common housing further comprises:
an upper housing; and
a lower housing.

4. The table controller of claim 3 wherein the PCB assembly is placed between the upper and lower housing.

5. The table controller of claim 3 wherein the hand switch is mounted in a recessed portion of the upper housing.

6. The control box of claim 4 wherein posts in the lower housing support the PCB assembly and locate it within the control box.

7. The control box of claim 6 wherein hooks on the upper housing snap into holes on the lower housing.

8. The control box of claim 7 wherein the lower housing is configured with a lower housing attachment rib that facilitates the connection of the front of the lower housing to the front of the upper housing.

9. The control box of claim 3 wherein the upper housing further comprises a hole for the tail.

10. The control box of claim 1 wherein the PCB assembly further comprises:
a microprocessor;
a power connector;
a motor connection port; and
a circuit board.

11. The control box of claim 10 wherein software in the microprocessor changes user input for the hand switch into the desired output.

12. The control box of claim 3 wherein mounting screw bosses extend out of the right and left sides of the upper housing.

13. The control box of claim 12 wherein mounting screw bosses further comprise mounting holes.

14. The control box of claim 3 wherein the upper housing further comprises a table top locating edge.

15. The control box of claim 1 wherein the hand switch further comprises a button for auto calibration.

16. The control box of claim 15 wherein the hand switch further comprises a status LED light.

17. The control box of claim 16 wherein the hand switch further comprises a plurality of buttons for programmable preset heights.
